(19) United States
(12) Patent Application Publication
(10) Pub. No.: US 2010/0081515 A1
(43) Pub. Date: Apr. 1, 2010

(54) Weights for grip length extensions to test golf clubs

(76) Inventors: James White, Lincoln, NE (US); Greg Johannesen, Lincoln, NE (US)

Correspondence Address: Shane Thielen, 1248 'O' Street, Suite 600, Lincoln, NE, 68508, US

(21) Appl. No.: 12/243,003

(22) Filed: Oct. 1, 2008

(51) Int. Cl. A63B 53/16; G01B 1/00

(52) U.S. Cl. 473/296; 473/297; 33/508; 473/409

(57) ABSTRACT

A weight joined to a grip length extension, further joined to a test golf club to produce a device outwardly indistinguishable from a production golf club. The assembled device is used as part of a golf club fitting system to emulate the swingweight of various production golf clubs.

### BACKGROUND AND PRIOR ART

1. Technical Field

The present invention relates to golf club fitting systems. Specifically, the invention teaches a device whereby a weight is added to a modified grip length extension such that the length, weight and balance of a test golf club may be precisely adjusted.

2. Description of Prior Art

Golf clubs traditional consist of a golf club head, a golf club shaft with distal and proximal ends, and a grip cover. The golf club head is permanently joined to the distal end of the golf club shaft and the grip cover is placed over the proximal end of the golf club shaft.

Many golfers elect to have a set of custom golf clubs fitted specifically to their swing characteristics. Some golf club fitting systems require the golfer to test numerous different golf clubs, each with a different length golf club shaft and a different weight golf club head. The golfer then identifies subjectively which golf clubs are best suited to the golfer.

Recently, golf club fitting systems have been developed that identify which golf clubs are best suited to the golfer based at least partially on objective measurements. One such fitting system includes a test golf club with a number of grip length extensions which can be attached to the proximal end of the test shaft to effectively produce clubs of differing length.

Fitting systems that include a test golf club with grip length extensions such as the one outlined in U.S. Pat. No. 7,195,565 also frequently require minute adjustments to weight, either to change the overall weight of the assembled test golf club, or to change the weight distribution of the assembled test golf club. Adjustments to the weight or balance of an assembled test golf club can be accomplished by adding weights to the golf club head.

One problem with fitting systems that include a test golf club with grip length extensions is that the assembled test golf club may not exactly emulate the characteristics of a production golf club. A fitting system that does not emulate the characteristics of production golf clubs, such as mass distribution and moment of inertia, cannot produce an optimum set of fitted golf clubs.

The traditional measure of the mass distribution and moment of inertia in a golf club is swingweight. The principles and applications of swingweight are known in the art.

Therefore, an object of the present invention is to provide a device for use with golf club fitting systems, to allow the user to adjust the balance of the assembled test golf club to more precisely emulate the swingweight of a production golf club.

Furthermore; while devices for adding weight to the proximal ends of production golf clubs are known in the art, no fitting system can easily test the effects of adding weight to the proximal end of a production golf club.

Therefore, a further object of the present invention is to provide a device for use with golf club fitting systems, to allow the user to test the effects of adding additional weight to the proximal end of a production golf club.

The present invention is primarily intended for use with golf club fitting systems that employ grip length extensions. Golf club fitting systems that employ grip length extensions must necessarily employ at least one test golf club capable of receiving interchangeable grip length extensions. Therefore, any reference to test golf clubs should be understood to refer to test golf clubs capable of receiving grip length extensions and any reference to an assembled test golf club should be understood to refer to a test golf club with a grip length extension attached.

Furthermore, any reference to grip length extensions should be understood to refer to grip length extensions intended for use with test golf clubs in a golf club fitting system, and any reference to a golf club fitting system should be understood to refer to a golf club fitting system that employs one or more test golf clubs and numerous interchangeable grip length extensions.

Because the present invention concerns golf clubs, any reference to the proximal end of an element should be understood to refer to the end nearest the body of the user when the assembled device is used as an ordinary golf club, and any reference to the distal end of an element should be understood to refer to the end furthest from the body of the user when the assembled device is used as an ordinary golf club.

### SUMMARY

The object of the present invention is to provide a device by which the length, weight and balance of an assembled test golf club may be adjusted precisely. The device comprises a weight, a modified grip length extension designed to receive the weight, a joining means for joining the weight to the modified grip length extension and a test golf club.

The user joins the weight to the modified grip length extension by the joining means. The user then joins the grip length extension to the test golf club by whatever means are known in the art. The assembled test golf club is identical in appearance to a production golf club.

The purpose of the invention is to allow the user to add weight to the proximal end of the assembled test golf club and thereby adjust the weight and balance of the assembled test golf club. The invention is most useful when used as part of a golf club fitting system where the user has access to a number of different, interchangeable weights. When used as part of a golf club fitting system, the user should employ whatever processes are ordinarily used in the golf club fitting system, and use the present invention to enhance the usefulness of those processes.

### LIST OF FIGURES

FIG. 1 is a perspective view of a test golf club shaft, golf club head, modified grip length extension, threaded collar and cylindrical threaded weight.

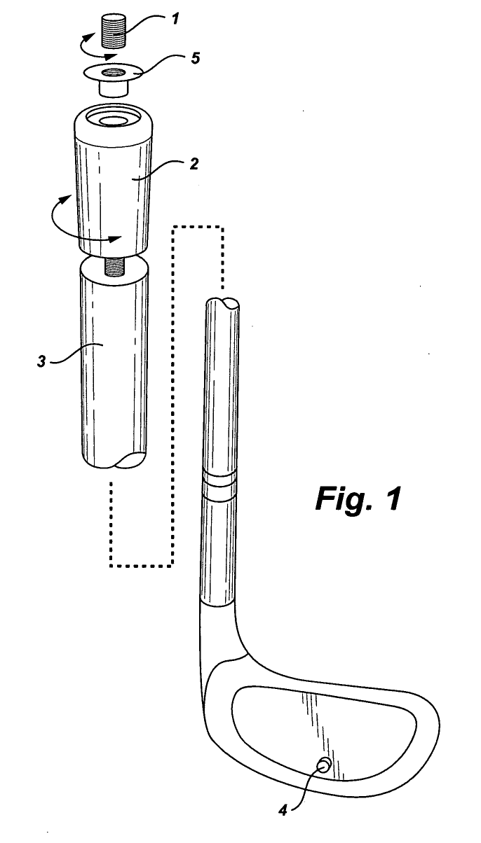

FIG. 2 is a side view of a test golf club shaft, a plurality of modified grip length extensions, threaded collar and cylindrical threaded weight.

FIG. 3 is a chart listing various production golf club shafts and their characteristics, along with the weight necessary to make the shaft of a test golf club with modified grip length extension equal as measured by swingweight.

FIG. 4 is a chart listing various production golf club shafts and their specifications as applied to a 6 iron.

FIG. 5 is a chart listing various production golf club shafts and their swingweight values given a known head weight and grip weight.

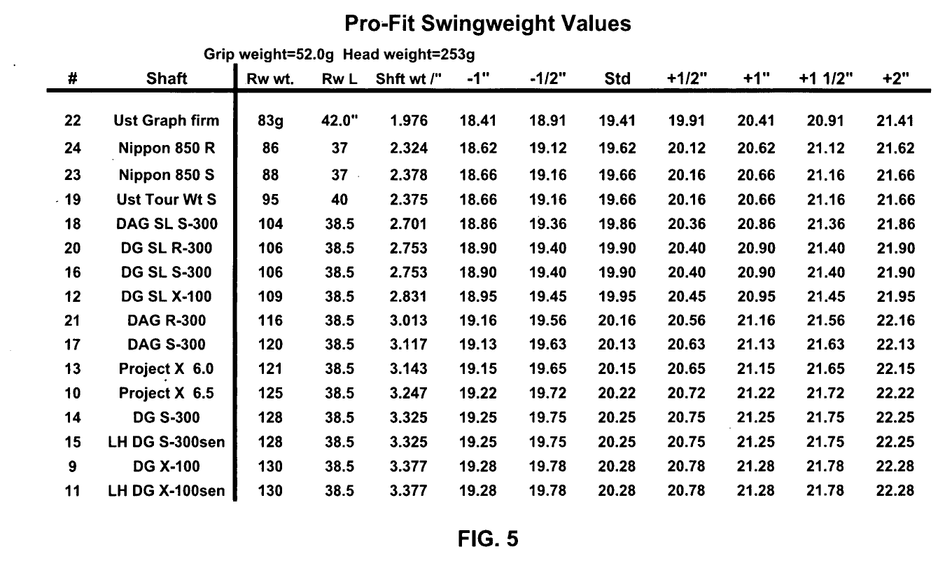

### DESCRIPTION AND PREFERRED EMBODIMENT

The present invention comprises a weight, a modified grip length extension, a joining means and a test golf club.

The weight is a known mass, and small enough in size to fit entirely within the modified grip length extension. The preferred embodiment of the weight is a small threaded cylindrical weight (1) commonly used to adjust the weight of golf club heads and well known in the art.

The modified grip length extension is a grip length extension modified to receive the weight by the joining means. The preferred embodiment of the modified grip length extension is a grip length extension with a round hole in the center of the proximal end (2).

The joining means is any means by which the weight may be joined to the modified grip length extension. The joining means may be permanent or non-permanent. The preferred embodiment of the joining means is a threaded collar (5) permanently joined to the modified grip length extension. The threaded collar is inserted into the modified grip length extension (2) so as to be flush with the surface of the modified grip length extension. The threaded collar accommodates the threaded cylindrical weight (1) that is the preferred embodiment of the weight.

The test golf club (3) is known in the art and otherwise unmodified for the present invention.

The inventors preferred embodiment of the invention is as part of a golf club fitting system. The user of the invention has access to numerous different, interchangeable weights within a range of useful weights. The range of useful weights depends on the weight of the grip length extension it will be joined to and the weight of the test golf club; therefore the range of useful weights is only meaningful relative to the assembled device. In the inventors preferred embodiment, the range of useful weights is from one (1) to sixteen (16) grams, to emulate production golf club shafts with masses from eighty-three (83) to one hundred thirty (130) grams.

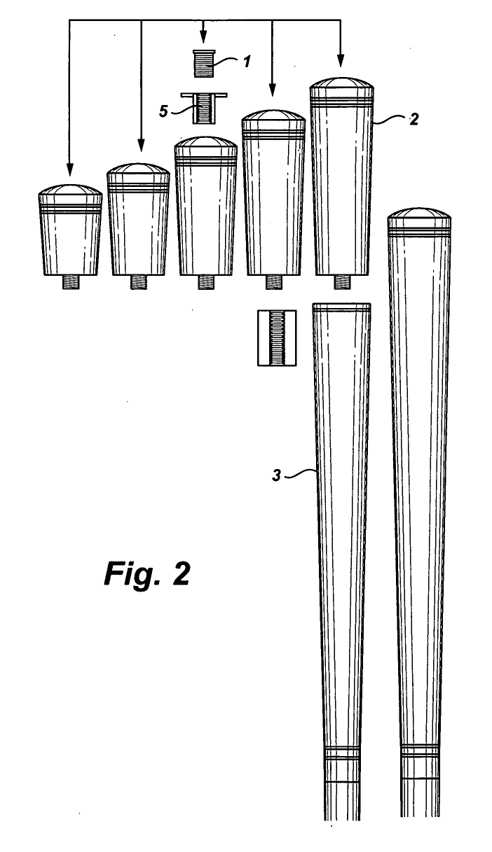

The user also has access to a plurality of modified grip length extensions of various lengths such as those illustrated in FIG. 2. The range of useful lengths of modified grip length extensions is that range known in the art of golf club fitting systems.

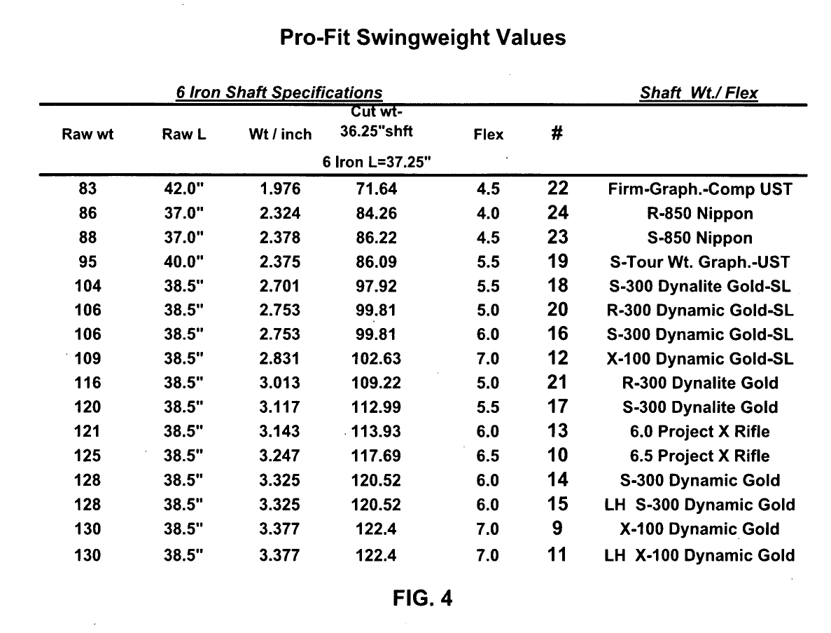

The assembled device, as part of a golf club fitting system, is intended to emulate the characteristics of a production golf club. FIG. 4 specifies the weight and length of certain production golf club shafts. The user selects a production shaft that the user wishes to emulate in the golf club fitting process, and then selects a weight and modified grip length extension such that when the weight is joined to the modified grip length extension, and the modified grip length extension is joined to the test golf club, the assembled test golf club possesses similar characteristics to a production golf club made with the production golf club shaft the user originally selected.

When used as part of a golf club fitting system, the user may select any modified grip length extension available to the user. By selecting modified grip length extensions of different length, the user may precisely modify the length of the test golf club.

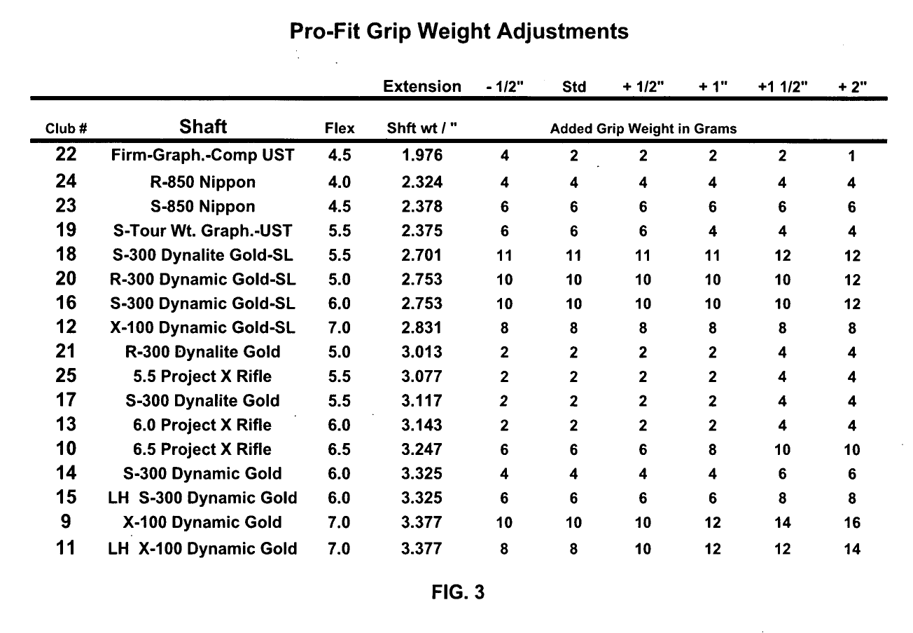

The user may then add weight to the head of the test golf club (4) through a process known in the art, and the user may add weight to the proximal end of the modified grip length extension through the invention described herein. In the inventors' preferred embodiment, the weight is initially selected by reference to a chart such as FIG. 3, which specifies the weight necessary to emulate the swingweight of a production golf club made with the listed shaft and the listed modified grip length extension. By changing the weight in the proximal end of the modified grip length extension, the user may precisely adjust the weight and balance of the test golf club.

Therefore the inventors have disclosed an invention by which the length, weight and balance of a test golf club may be precisely adjusted.

What is claimed is:

1. A device suitable for precisely adjusting the length, weight and balance of a test golf club, such device comprising
(a) a weight,
(b) a modified grip length extension, and
(c) a means of joining the weight to the grip length extension.

2. The invention of claim 1 further comprising a test golf club.

3. The invention of claim 1 where the means of joining the weight to the grip length extension is not permanent.

4. The invention of claim 2 where the means of joining the weight to the grip length extension is not permanent.

5. The invention of claim 2 where the device is equivalent to a production golf club as measured on a swingweight scale reader.

6. A method for selecting a weight from a plurality of weights in a golf club fitting system, such method comprising the steps of
(a) selecting a test golf club and modified grip length extension by whatever means are ordinarily used in the golf club fitting system,
(b) joining the test golf club and modified grip length extension to form an assembled test golf club by whatever means are ordinarily used in the golf club fitting system,
(c) selecting a weight from the plurality of weights,
(d) joining the weight to the assembled test golf club by a non-permanent joining means,
(e) testing the assembled test golf club on a swingweight scale reader, and
(f) if the assembled test golf club does not match the swingweight of the production golf club that the user attempted to emulate,
(i) selecting a different weight from the plurality of weights,
(ii) replacing the existing weight with the different weight, and
(iii) continuing from step (e).

7. The invention of claim 5 where the plurality of weights ranges in mass from 1 to 16 grams.
